(19) United States
(12) Patent Application Publication
(10) Pub. No.: US 2014/0172681 A1
(43) Pub. Date: Jun. 19, 2014

(54) Process for Verifying Data Identity for Lending Decisions

(71) Applicant: On Deck Capital, Inc., New York, NY (US)

(72) Inventors: Greg Lamp, New York, NY (US); Matthew Gillen, New York, NY (US); Michael White, New York, NY (US)

(73) Assignee: On Deck Capital, Inc., New York, NY (US)

(21) Appl. No.: 14/079,956

(22) Filed: Nov. 14, 2013

Related U.S. Application Data
(60) Provisional application No. 61/726,241, filed on Dec. 14, 2012.

(51) Int. Cl. G06Q 40/02

(52) U.S. Cl. CPC G06Q 40/025
USPC 705/38

(57) ABSTRACT

The disclosure relates to a process for matching the identify of publically available data to a potential borrower for a business loan. Using the process, a lender can utilize publicly available data regarding a loan applicant, verify with some certainty that the data actually corresponds to the loan applicant, and use that data in conjuction with other information to make a lending decision. The disclosure is directed toward loan transactions for small businesses.

### CROSS REFERENCE TO RELATED APPLICATIONS

This is a non-provisional which claims priority to U.S. Provisional Application No. 61/726,241, filed on Nov. 14, 2012, the entirety of which is hereby incorporated by reference.

### FIELD OF THE INVENTION

The disclosed embodiments relate generally to a process for matching the identity of publically available data to a potential borrower for a business loan.

### BACKGROUND

Traditionally, financial products, such as loans, have been marketed largely through financial institutions' literature and agents. The financial service provider relies on the agents for a large number of tasks, including acquiring demographic information, verifying the accuracy of the information, evaluating the information, and offering to sell products to the customer.

Technology has changed the landscape of the financial services industry such that agents play an increasingly shrinking role in marketing the financial products to potential borrowers. As the Internet has grown in popularity, potential borrowers shop for financial services over the Internet without the aid of an agent. A growing number of online companies also provide loan services; however, these online companies currently fall short of fully automating the loan process. In the case of financial institutions, potential borrowers can apply for loans or other financial services online; however, the loan approval process still requires the involvement of an agent. Third party providers of financial services can provide a list of available financial services based on criteria provided by the potential borrower, but the potential borrower must still contact the financial services agency directly or await a contact by an agent of the financial services agency.

A large percentage of these potential borrowers are the owners of small businesses. Small businesses encounter a number of unique challenges when trying to secure financing. The lack of a cost-effective infrastructure to efficiently analyze small businesses has forced financial institutions to rely on an inaccurate shortcut: The personal credit score of the owner. It is a fast and inexpensive way to make a judgment. However, it reflects the personal payment history of an individual, not the current financial state of the business. While this piece of data is easy to procure, it is a highly inaccurate indicator of creditworthiness. The problem in relying on the personal credit score becomes especially pronounced because many small business owners use personal credit to initially build their businesses, which creates a roadblock to accessing capital once they have become more established.

Thus, it is desirable for lenders to rely on more information than just the personal credit score of a small business owner. The internet is rife with available information regarding particular small businesses and owners. For example, a number of web sites contain online reviews of businesses from customers. One problem with using this information, however, is ensuring that the data obtained actually corresponds to the loan applicant, i.e., potential borrower. Data that is incorrectly attributed to a potentially borrower or the business of that borrower can distort the lending assessment process. The present invention addresses this issue by providing a method for comparing and matching potential applicant data with other information obtained regarding the loan applicant or the applicant's business.

### SUMMARY

The present invention addresses the needs of lenders by creating a method which helps verify whether information which could be pertinent to a lending transaction for a potential borrower actually belongs to that potential borrower. Utilizing the present invention allows a lender to rely on publicly available data to make quicker and more accurate lending assessment for small businesses.

In one embodiment, the present invention relates to a process for verifying the association of publicly available data to a loan applicant comprising: receiving loan application information from a loan applicant; locating a data record potentially belonging to said applicant; extracting identifying information associated with said data record; standardizing the identifying information and the corresponding loan application information; assessing the similarity between the identifying information and the corresponding loan application information using comparison metrics; generating a numerical representation of the similarity between the identifying information and the corresponding loan application information; and evaluating the numerical representation of similarity to determine whether the identifying information sufficiently corresponds to the loan applicant. In preferred embodiments, the loan applicant is a small business. In other embodiments, the described process is automated.

In certain embodiments, the loan application information is received via a network from the loan applicant's computing system. This network can be, among other things, the Internet. Similarly, in certain embodiments, the data record potentially belonging to the applicant is found on the web. The data record can be, for example, an online review.

Another embodiment of the present invention further comprises organizing the identifying information into at least one field. The at least one field might comprise a business name, phone number, address, or geographic coordinates. In further embodiments, a numerical representation of the similarity between the identifying information and the corresponding loan application information is generated for each field.

In one embodiment of the present invention, the comparison metrics referenced above comprise at least one of: the longest common substring, the number of common words, the Levenshtein distance, the actual distance, and combinations thereof. Informally, the Levenshtein distance between two words is equal to the number of single-character edits required to change one word into the other. In certain embodiments, the numerical representation of similarity comprises a number between 0 and 1.

In additional embodiments, if the identifying information sufficiently corresponds to the loan applicant, the data record is used in making a lending decision.

### BRIEF DESCRIPTION OF THE DRAWINGS

FIG. 1 shows a flow chart of one embodiment of a method of verifying information for a potential borrower.

### DETAILED DESCRIPTION

The present invention relates to a method for verifying whether obtained information which could be pertinent to a lending transaction for a potential borrower actually belongs to that potential borrower. The system compares various types of the potential borrower information, such as name and address, with corresponding categories of information from a data source. The information is loaded, processed, and compared using comparison metrics specific to each category of information. This results in a score for that particular category of information. The scores from the various categories are then assessed together to determine whether the scores indicate that the information obtained is sufficiently likely to correspond to the potential borrower.

A potential borrower for a loan has certain identifying information such as name, address, phone number, and geographic coordinates of location (i.e., longitude/latitude). There are many other types of information that can be used, including any information that can be used to help identify an individual or a business. This indentifying information can be broken down further, for example into information pertaining to the individual themselves or to the individual's business. The potential borrower provides the information to the lender when applying for a loan. This can be done, for example, over a web interface. The identifying information can also be derived from other information obtained from the potential borrower. For example, geographic coordinates can be obtained from the buyer's address. The identifying information regarding the potential borrower is stored by the lender.

Publicly available data regarding both individuals and businesses can be utilized in the lending process. Specifically, such information can be used in making credit policy and underwriting decisions. Such data can be obtained, for example, from the internet. Some examples of websites where useful data regarding a potential borrower might be obtained include YELP.COM, FOURSQUARE, GOGGLE PLACES, and BETTER BUSINESS BUREAU. Some of the benefits of using such data in the lending process include: (1) it is low cost—the only real cost is bandwidth and data storage; (2) it is relevant since information like online reviews has been shown to have a strong correlation with business performance and risk; (3) it is flexible since because it is publicly available, the lender can dictate the restrictions on how it is used; (4) it can be backward-looking since it can show how a well a business satisfied previous customers; (5) it can also be forward-looking since web data and reviews drive future business; and (6) it is orthogonal to more conventional types of information used in the lending evaluation process and adds incremental value to the traditional credit score or platform.

The publicly available data will typically have identifying information associated with it as well. For example, an online review of a business will likely contain the business name, address, and phone number. Geographic coordinates can also be determined from the address. Such identifying information might also be obtained through the application programming interface (“API”) of the web service being used as the source of the data. This identifying information can be extracted and stored by the lender.

Prior to comparing the identifying information associated with the publicly available data to the identifying data provided by the potential borrower, the two sets of identifying information are standardized. Standardizing in this context involves, for example, removing punctuation, converting the letter to all lowercase, and standardizing common abbreviations such as those found in a street address (Rd—road, Dr—drive, 1st—first, North—N, etc.)

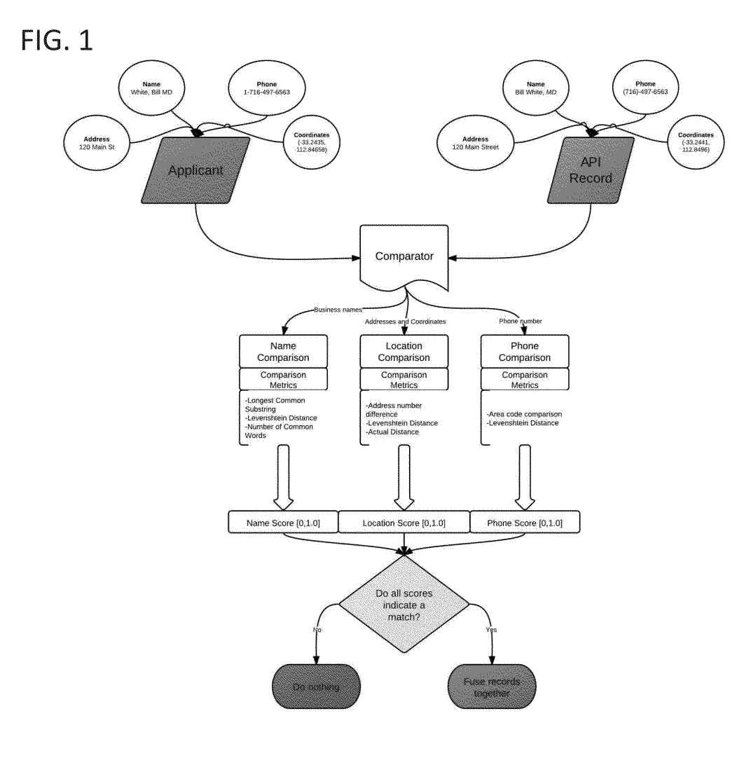

The identifying data from the loan applicant and from the publicly available information are then fed to a comparator program (“comparator” in FIG. 1). The comparator can be a program stored on a computing system of the lender. The comparator compares the various pieces of identifying information within the various fields in which they are grouped (i.e., name, address, phone number, geographic coordinates, etc.). In one embodiment, a fuzzy string methodology is used to compare the identifying records. Comparison metrics are generated for each field. This creates a numerical representation of the similarity between the two strings of data. For example, for a name field, the comparison can involve the longest common substring, the Levenshtein distance, and/or the number of common words between the two strings. For a name field, the name associated with the publically available data should match either the company name or the company's “doing business as” name. As another example, for a phone number field, the comparison metrics could involve an area code comparison and or the Levenshtein distance between the two fields. As another example, for a street address, the comparison metrics can involve the address number difference, the Levenshtein distance, and/or the actual distance between the two strings. The street address associated with the publicly available data should be compared with the address given in the loan application. And in yet another example, the comparison metrics for two sets of geographic coordinates can involve the Levenshtein distance and/or the actual distance. As different sets of data can be matches in many different ways, the comparison metrics can be an attempt to identify the aspects of what it means for two pieces of data to refer to the same thing, i.e., be a match. Using an example of business names, “Subway” and “Subway Sandwiches” may be a match for the same business just as “Dr. Ben Smith—Dentist” and “Dentist Smith, Ben Dr.” is. However, the two sets of business names themselves indicate a match in different ways. The comparison metrics attempt to capture the different types of indications of a match.

Using the comparison metrics, a pre-programmed model can be used by the comparator to score the comparisons between the identifying information provided by the applicant and the identifying information from the publicly available information. Due to the many different indicators of a match between two sets of data, the relationship between the different comparison metrics is often complex. The comparisons scores for the various fields can be aggregated, but in a preferred embodiment are scored separately for the various fields. In a further embodiment, the comparisons scores for the various fields are computed as a number between 0.0 and 1.0 with 0.0 signifying no match, and 1.0 signifying a perfect match (See examples of name score, location score, and phone score in FIG. 1).

The comparison scores are then evaluated to determine whether they meet a pre-determined criteria indicating an identification match. In one embodiment, the criteria for determining a match can be coded into an algorithm stored on a computing system of the lender. In another embodiment, the similarity between the strings is scored by a machine learning model. In a further embodiment, the machine learning model can be a support vector machine. The machine learning model is trained with examples from the lender's existing pool of applicant data. For example, using the comparison metrics and the comparator, comparison scores are generated for two data fields (e.g., business names) known to be a match or known not to be a match. The scores are incorporated in the model in this manner, thereby training the model to distinguish or create a boundary between matching and non-matching data. As discussed, the relationship between the comparison scores generated for each comparison metric can be complex. Thus the machine learning model can be trained with a large number of examples in order to better characterize the complex boundary between matches and non-matches.

The process then determines whether the comparison scores indicate a match. In some embodiments, a probability for the scores being a match is also generated. If the scores do indicate a match, the computing system of the lender can record this and store the publically available data corresponding to the identifying information. Other actions can be taken as well, for example, fusing the record with the identifying information. If the process determines that there is not a match, the publicly available data is not associated with the potential borrower.

In one embodiment of the invention, a potential borrower is provided with a user interface to verify whether a piece of publically available data belongs to that potential borrower. This piece of publically available data can be one which was already verified by the method described as belonging to the potential borrower. As an example, a potential borrower signing up through a customer portal for a online small business loan can be presented with a graphical representation of web data that has been matched to the potential borrower's business to verify that the match is valid.

The invention is now further described by way of a non-limiting example.

### EXAMPLE

As one example of the inventive process, the business names “Mid America Parts” and “MID-AMERICA PART, LLC” can be compared. The two entries are first normalized by a computing system to remove punctuation and make the entire entries lower case. So the two entries become “mid america parts” and “midamerica part 11c”. Scores for the similarity are then generated by a computing system using a number of comparison metrics. For example, one metric is IcsNorm, the length of the longest substring shared by the two entries, normalized by the length of the entries. Applying IcsNorm to the two entries above results in a score of 0.705. Another metric is levNorm, the levenshtein distance between the two entries, normalized by the length of the entries. Applying levNorm to the two entries above results in a score of 0.263. Another metric is Ratio, the percent of the words in each entry that are the same. Applying Ratio to the two entries results in a score of 0.0. Another metric is weightedRatio, or the percent of words occurring in both entries weighted more heavily for words that contain more characters. Applying weightedRatio to the two entries results in a similarity score of 83. Another metric is partialRatio, the percent of stemmed words occurring in both entries. Applying partialRatio to the two entries results in a score of 0.88. Another metric is tokenSortRatio, the number of words that are the same in each index for each entry after the words are sorted (such as alphabetically). Applying tokenSortRatio to the two entries results in a similarity score of 0.66. Another metric is tokenSetRatio, or the percent of duplicated words which occur in both entries. Applying tokenSetRatio to the two entries above results in a score of 0.66. A final example metric is wordDiscjunction, the sum of the relative frequencies of words that only occur in one entry. Applying word Disjunction to the two entries results in a similarity score of 0.0.

The similarity scores for the various metrics can be aggregated by a program on a computing system that applies a weighting factor to each of the scores for the individual metrics to determine a probability of a match between the two entries. This probability can itself be aggregated with probability scores from other indicies (address, phone number, etc.) to determine an overall probability that the identifying information refers to the same entity, and as a consequence, whether the data attached to the indentifying information is likely to belong to the entity in question, for example, a specific small business seeking a loan.

Although the present invention has been described with reference to preferred embodiments, workers skilled in the art will recognize that changes may be made in form and detail without departing from the spirit and scope of the invention.

We claim:

1. A process for verifying the association of publicly available data to a loan applicant, comprising:
receiving loan application information from a loan applicant;
locating a data record potentially belonging to said applicant;
extracting identifying information associated with said data record;
standardizing the identifying information and the corresponding loan application information;
assessing the similarity between the identifying information and the corresponding loan application information using comparison metrics;
generating a numerical representation of the similarity between the identifying information and the corresponding loan application information;
evaluating the numerical representation of similarity to determine whether the identifying information sufficiently corresponds to the loan applicant.

2. The process of claim 1, wherein the loan application information is received via a network from the loan applicant's computing system.

3. The process of claim 1, wherein the data record potentially belonging to the applicant is found on the web.

4. The process of claim 3, wherein the data record is an online review.

5. The process of claim 1, wherein the loan applicant is a business.

6. The process of claim 1, further comprising organizing the identifying information into at least one field.

7. The process of claim 6, wherein the at least one field comprises business name, phone number, address, or geographic coordinates.

8. The process of claim 1, wherein the comparison metrics comprise at least one of: the longest common substring, the number of common words, the Levenshtein distance, the actual distance, and combinations thereof.

9. The process of claim 1, wherein the numerical representation of similarity comprises a number between 0 and 1.

10. The process of claim 6, wherein a numerical representation of the similarity between the identifying information and the corresponding loan application information is generated for each field.

11. The process of claim 1, wherein if the identifying information sufficiently corresponds to the loan applicant, the data record is used in making a lending decision.

12. The method of claim 1, wherein each step is automated.

13. The method of claim 12, further comprising verifying the borrower's operating account information prior to providing loan funding.

14. The method of claim 1, wherein the obtaining selected loan terms comprises:
obtaining a loan amount from said borrower's computer system;
displaying total loan cost, interest, and fees based on said loan amount; and
obtaining a loan duration from said borrower's computer system.

15. The method of claim 2, wherein said network is the Internet and said loan application information is received at a website on said Internet.

16. The method of claim 1, wherein a machine learning model is used to evaluate the numerical representation of similarity to determine whether the identifying information sufficiently corresponds to the loan applicant.
